(19) United States
(12) Patent Application Publication
(10) Pub. No.: US 2012/0213345 A1
(43) Pub. Date: Aug. 23, 2012

(54) MEETING SCHEDULER SENDING REMINDERS

(76) Inventor: Anjul Agarwal, Namur (BE)

(21) Appl. No.: 13/391,324

(22) PCT Filed: Aug. 9, 2010
(86) PCT No.: PCT/EP2010/061540

§ 371 Date: May 7, 2012

(30) Foreign Application Priority Data
Aug. 21, 2009 (IN) 1991/CHE/2009

(51) Int. Cl. G06F 15/16; H04M 11/00; H04M 3/42

(52) U.S. Cl. 379/88.18; 709/204; 709/206; 379/202.01

(57) ABSTRACT

A method and system for informing invitees (104) in a scheduled meeting meeting about the meeting, the method comprising steps of a server retrieving contact numbers of at least one invitee of the meeting where confirmation from the invitee is not received before a predetermined time (509); and the server contacting said invitee for said confirmation using at least one of said contact numbers (507).

### FIELD OF INVENTION

This invention relates to a telecommunication network based meeting scheduler, and particularly related to intimating the invitees of a meeting on a telecommunication network and confirming the attendance thereof.

### BACKGROUND

Currently, once the organizer of a meeting decides the date, time and list of invitees for the meeting, the organizer informs invitees of the date and time of the meeting with an email sent using a mail client such as Microsoft Outlook, Outlook Express and so on. The email sent by the organizer comprises of options like “accept the invitation”, “reject the invitation”, “suggest a new time” and so on. The invitees respond to the organizer with a second email, where the second email indicates their availability for the meeting. The second email can be send by an invitee by selecting an option from the list of options presented in the email sent by the organizer. If the invitee is available at the date and time decided by the organizer, then the invitee may select the “accept the invitation” option. On selecting the “accept the invitation”, the second email will indicate to the organizer that the invitee will be available for the meeting. If the invitee does not want to attend the meeting, then he may select the “reject the invitation”. On selecting the “accept the invitation”, the second email will indicate to the organizer that the invitee will be available for the meeting. If the invitee wants to attend the meeting, but the time of the meeting is not convenient, then he may select the “suggest a new time” option. The invitee can then suggest a new time for the meeting. The second email will indicate to the organizer that the invitee will not be available at the previous time for the meeting and the new time suggested by the invitee.

However, if at least one of the invite is not able to access email, the invitee will not be informed of the meeting. The organizer will not have any response from the invitee, and is unable to know if the invitee will participate in the meeting.

### SUMMARY

Accordingly, the embodiments herein provides a method for informing invitees in a scheduled meeting about the meeting, the method comprising steps of: a server retrieving contact numbers of at least one invitee from a plurality of address books of the meeting where confirmation from the invitee is not received before a predetermined time set by organizer of the meeting.; and the server contacting the invitee through a call server using Interactive Voice Response (IVR), Short Messaging Service (SMS) or Instant Messaging (IM) for the confirmation using at least one of the contact numbers. The contact number belongs to one of a mobile phone belonging to the invitee; a PSTN phone belonging to the invitee; an IP phone belonging to the invitee; and a phone using a combination of wireless technologies. The server contacts the invitee by selecting one of the contact numbers, the selection depending on a plurality of factors comprising of preferences of the invitee; preferences of the organizer; and cost of contacting the invitee on the contact number. The organizer is notified if no response is received from the invitee.

A system for informing invitees in a scheduled meeting about the meeting, the server comprising of a means for retrieving contact numbers of at least one invitee of the meeting from a plurality of address books where confirmation from the invitee is not received before a predetermined time; and a call server for contacting the invitee for the confirmation using at least one of the contact numbers though Interactive Voice Response (IVR), Short Messaging Service (SMS) or Instant Messaging (IM). The server is configured to notify organizer of the meeting if no response is received from the invitee.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This invention is illustrated in the accompanying drawings, through out which like reference letters indicate corresponding parts in the various figures. The embodiments herein will be better understood from the following description with reference to the drawings, in which:

FIG. 1 depicts a network, according to embodiments disclosed herein;

FIG. 2 depicts a server, according to embodiments disclosed herein;

FIG. 3 depicts a server, according to embodiments disclosed herein;

FIG. 4 depicts a network, according to embodiments disclosed herein; and

FIGS. 5a and 5b are flowcharts depicting the method for informing an invitee about a scheduled meeting, according to embodiments disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

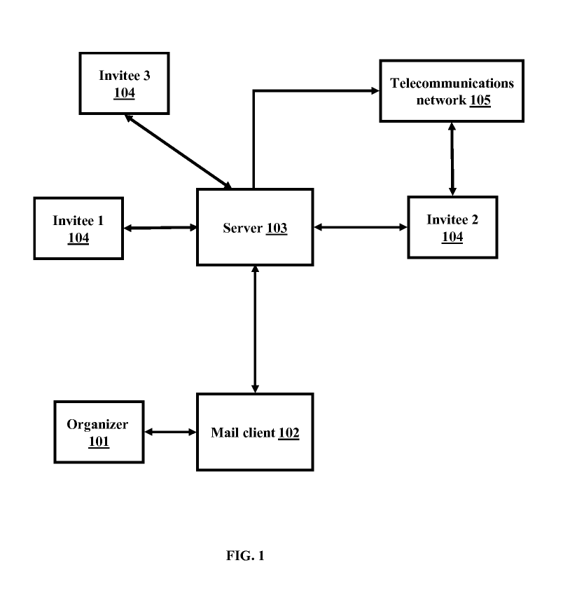

The embodiments herein ensure informing all invited invitees in a meeting of the meeting using at least one telecommunications network. Referring now to the drawings, and more particularly to FIGS. 1 through 5, where similar reference characters denote corresponding features consistently throughout the figures, there are shown preferred embodiments.

Embodiments herein disclose a method and system for informing all invitees to a meeting using telecommunication networks. An organizer schedules the meeting and sends notifications using email to all the invitees. The invitees are expected to respond to the email with their availability at the time of the meeting. In case, invitees do not respond to the email within a predetermined time, then a server connected to the network of the organizer retrieves contact numbers of non-responding invitees. The server then attempts to contact the non-responding invitees using the contact numbers. If the server is not able to contact the non-responding invitees, then the server notifies the organizer of the same.

FIG. 1 depicts a network, according to embodiments disclosed herein. FIG. 1 comprises of an organizer 101, a mail client 102, a server 103, a plurality of invitees 104 and a telecommunications network 105. The organizer 101 plans the meeting and fixes a preferred date, time and list of invitees 104 for the meeting. The organizer 101 sends the date and time of the meeting to the invitees 104 in an email using the mail client 102. The mail client 102 could be any suitable mail client application like Microsoft Outlook, Microsoft Outlook Express, and Mozilla Thunderbird and so on. The mail client 102 sends the emails to the invitees using a server 103. The server 103 could be a mail application server, an Intelligent Network (IN) server or any other suitable server. The server 103 stores the details of the meeting along with various options selected by the organizer 101 in a database present in the server 103. The organizer 101 may set options like urgency of the meeting, a predetermined time to wait for a response before attempting to contact non-responding invitees by accessing the server 103. The organizer 101 may also set the options using his mail client 102, which then communicates the options to the server 103.

The server 103 waits for the predetermined time for receiving responses from all the invitees. The predetermined time set by the organizer 101 could be a specific amount of time from sending the email or a specific amount of time away from the time of the meeting. In an example, the organizer 101 could set the predetermined time as 12 hours from the time of scheduling the meeting. In another example, the organizer 101 could set the predetermined time as 6 hours before the scheduled time of the meeting. After the predetermined time lapses, the server 103 determines the list of invitees who have not responded to the email, hereinafter referred to as non-responding invitees. The non-responding invitees may have not responded to the email due to a lack of access to email or any other reason. The organizer 101 may also not set any predetermined time, but set an urgency level for the meeting. The predetermined time has default values, which depend on the urgency of the meeting. For example, if the organizer 101 sets the urgency of the meeting as ‘very high’, then the server may wait for a shorter period of time, before attempting to contact non-responding invitees. If the urgency of the meeting is ‘low’, then the server may wait for a longer period of time before attempting to contact non-responding invitees. The server 103 retrieves the contact numbers of all the non-responding invitees. The contact numbers could be retrieved from the address book of the organizer 101. The contact numbers could also be retrieved from address books stored in the server 103. Contact numbers of a specific non-responding invitee could be a number belonging to a Public Switched Telephone Number (PSTN) phone, a number belonging to a mobile phone, a number belonging to an Internet Protocol (IP) phone or a number belonging to any other telecommunications device capable of initiating communication or receiving communication.

The server 103 attempts to contact the non-responding invitees using one of the retrieved contact numbers. In some embodiments, the contact number used to contact the non-responding numbers may be any random number chosen from the retrieved contact numbers. In some other embodiments, the contact number used to contact the non-responding numbers may be a number which has been set as the preferred contact number. The invitee may set any one of his contact numbers as his preferred number. The invitee might also set preferences as to the time he wants to be contacted. For instance, an invitee might say that he is to be contacted on his phone between 6 PM to 9 PM. An invitee might also set up options that he is to be contacted only in office hours. An invitee might set up an option that he can be contacted on his phone at any time, if the meeting is urgent. If the meeting is not very urgent, the user might only want to be contacted on his office phone. The preferred number set by the invitee may belong to his PSTN phone, his mobile phone or his IP phone. The organizer may also set a contact number of an invitee as the preferred number. The preferred number set by the organizer may belong to his PSTN phone, his mobile phone or his IP phone. The server 103 may also look at the cost of communication. For instance, a call to an IP phone may be cheaper than a mobile phone, so the server 103 will first attempt to initiate communication with the IP phone. If the communication with the IP phone fails, then the server 103 tries the other contact number in increasing order of cost of communication. The server 103 initiates communication to the non-responding invitee. The type of communication initiated depends on the type of telecommunications network to which the contact number belongs. If the contact number belongs to a PSTN phone, then the communication may be through Interactive Voice Response (IVR). If the contact number belongs to a mobile phone, then the communication may be through IVR or a Short Message Service (SMS). If the contact number belongs to an IP phone, the communication may be through any one of IVR, a SMS or an Instant Message (IM).

A non-responding invitee may respond to the reminder using the same type of communication, as was used to notify him. The response of the non-responding invitee may be a confirmation message confirming his participation in the scheduled meeting. The response of the non-responding invitee may be a refusal to participate in the scheduled meeting. The response of the non-responding invitee may be a suggestion for a new time for the meeting. If IVR was used to notify the non-responding invitee, then the invitee may respond using the same IVR communication session. The response may be in the form of opting for an option presented to him in the IVR communication session. The IVR communication session could present the non-responding invitee with an option of pressing a specific key to confirm his availability for the meeting. The non-responding invitee may also get an option to press a second key to indicate his unavailability for the meeting. The non-responding invitee may also further be provided an option of suggesting a new date and time for the meeting. The IVR communication session could also use verbal inputs from the non-responding invitee.

If SMS was used to notify the non-responding invitee, then the non-responding invitee may reply to the SMS. The SMS sent by the non-responding invitee may be in a pre-specified format. If the non-responding invitee wants to send a SMS confirming his availability for the meeting, the SMS may contain “YES”. If the non-responding invitee wants to send a SMS confirming his unavailability for the meeting, the SMS may contain “NO”. If the non-responding invitee wants to send a SMS confirming his unavailability for the meeting and suggest a new timing for the meeting, the SMS, in an example, may contain “NO—dd/mm/yyyy, YY:YY”, where dd/mm/yyyy is the new date suggested for the meeting and YY:YY is the time suggested for the meeting in a 24 hour format.

If IM was used to notify the non-responding invitee, then the non-responding invitee may use the same IM communication session to respond. If the non-responding invitee wants to send an IM confirming his availability for the meeting, the IM may contain “YES”. If the non-responding invitee wants to send an IM confirming his unavailability for the meeting, the IM may contain “NO”. If the non-responding invitee wants to send an IM confirming his unavailability for the meeting and suggest a new timing for the meeting, the IM, in an example, may contain “NO—dd/mm/yyyy, YY:YY”, where dd/mm/yyyy is the new date suggested for the meeting and YY:YY is the time suggested for the meeting in a 24 hour format. The examples used herein are only for illustration purposes and should not be construed as limiting the coverage of the invention.

The server 103, on receiving the response from the non-responding invitee, informs the organizer 101 of the response though his mail client 102.

If the non-responding invitee does not respond on the contact number, then the server 103 initiates communications to other contact numbers of the non-responding invitees. If the non-responding invitee does not respond on any of his contact numbers, then the server 103 to attempt to initiate communications to the non-responding invitees after a specific period of time. The period of time may be specified by the organizer 101. The server 103 may attempt to contact non-responding invitees for a predetermined number of attempts. The predetermined number of attempts to attempt to contact the non-responding invitee may be specified by the organizer 101.

If the organizer 101, after receiving responses from invites, wishes to reschedule the meeting, he may reschedule the meeting. The organizer 101 may then select options on how he wants to contact the invitees. The organizer 101 may opt to seek responses from the invitees of the rescheduled meeting by email. He may also opt to seek responses from the invitees of the rescheduled meeting using the embodiments as disclosed above.

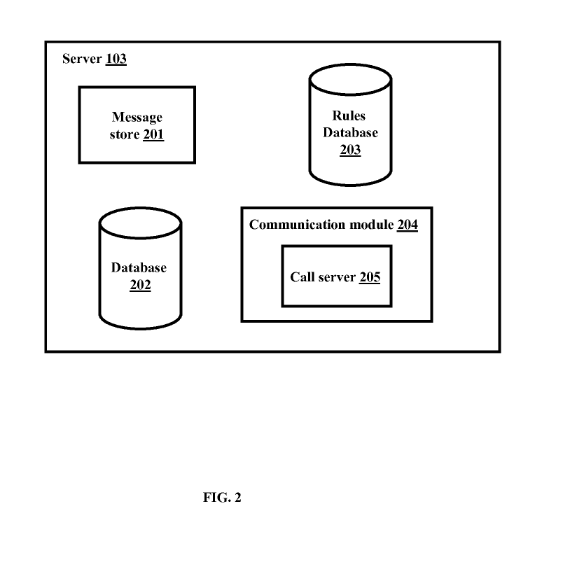

FIG. 2 depicts a server, according to embodiments disclosed herein. The server 103 comprises of a message store 201, a database 202, a rules database 203 and a communication module 204. The communication module 204 further comprises of a call server 205. The message store 201 is used for storage of emails. Messages are also stored temporarily in the message store 201. The database 202 is a database of user accounts that the mail server recognizes and will deal with in the local network where the server 103 is present. The database 202 also comprises of address books of the users using the server 103. The database 202 also contains the details of a meeting scheduled by the organizer 101 along with various options selected by the organizer 101. The rules database 203 comprises of rules which determine how the server 103 reacts when determining destination of an email, or possibly react to the sender of an email. The communication module 204 comprises of components that handle the transfer of messages to and from other servers 103 and email clients 102. Depending upon the requirements of the server 103, there may be a number of other modules installed on the server 103 for use.

The server 103 waits for the predetermined time for receiving responses from all the invitees. After the predetermined time lapses, the server 103 determines the list of non-responding invitees. The server 103 retrieves the contact numbers of all the non-responding invitees from the mail client 102 of the organizer 101 or the database 202. The server 103 triggers the call server 205 to initiate communication with non-responding invitees using any one of the retrieved contact numbers. The call server 205 is capable of initiating communication with PSTN phones, mobile phones and IP phones. The call server 205 is capable of initiating an IVR communication, a SMS communication or an IM communication. If the first contact number attempted by the call server 205 does not get a response, the server 103 instructs the call server 205 to attempt the other contact numbers of the non-responding invitee. The call server 205, on receiving a response from a non-responding invitee, updates the server 103 with the response. The server 103 further informs the organizer 101 of the response though his mail client 102. If the call server 205 is unable to contact the non-responding invitee, then the call server 205 informs the organizer 101 of the same through the server 103 and mail client 102.

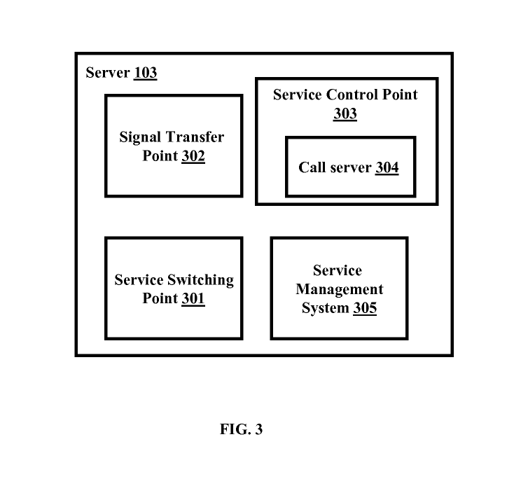

FIG. 3 depicts a server according to embodiments disclosed herein. The server 103 further comprises of a Service Switching Point (SSP) 301, Signal Transfer Point (STP) 302, a Service Control Point (SCP) 303 and a Service Management System 306. The SCP 303 further comprises of a call server 304 and a database 305. SSP 301 is a switch that is used to originate and terminate communication. STP 302 handles switching between the various networks connected to the server 103. SCP 303 interfaces between the SSP 301 and the STP 302. The SCP 303 contains the service logic to act on types of calls and features available on the server 103. The database 305 contains the details of a meeting scheduled by the organizer 101 along with various options selected by the organizer 101. The Service Management System 306 is a server administrator interface, which can be used by an administrator of the server 103 to access the server and configure the same.

The SCP 303 waits for the predetermined time for receiving responses from all the invitees. After the predetermined time lapses, the SCP 303 determines the list of non-responding invitees. The SCP 303 retrieves the contact numbers of all the non-responding invitees. The SCP 303 triggers the call server 304 to initiate communication with non-responding invitees using any one of the retrieved contact numbers. The call server 304 initiates communication using the SSP 301. The SSP 301 is capable of initiating communication with PSTN phones, mobile phones and IP phones. The SSP 301 is capable of initiating an IVR communication, a SMS communication or an IM communication. If the first contact number attempted by the call server 304 does not get a response, the SCP 303 instructs the call server 304 to attempt the other contact numbers of the non-responding invitee. The call server 304, on receiving a response from a non-responding invitee, updates the SCP 303 in the server 103 with the response. The server 103 further informs the organizer 101 of the response though his mail client 102. If the call server 304 is unable to contact the non-responding invitee, then the call server 304 informs the organizer 101 of the same through the server 103 and mail client 102.

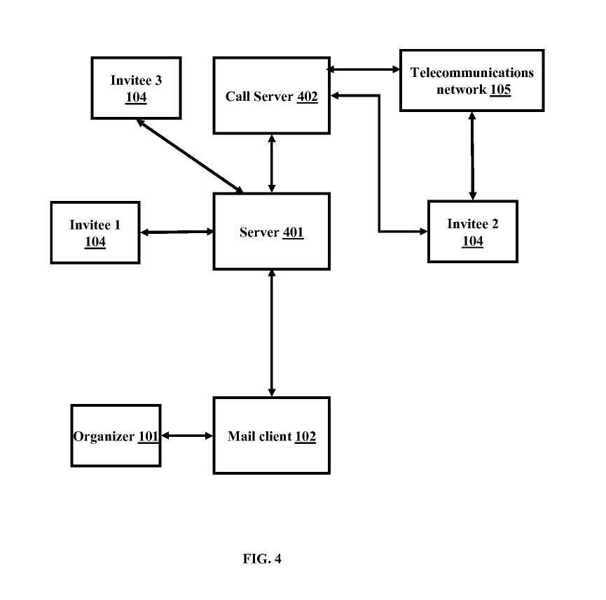

FIG. 4 depicts a network, according to embodiments disclosed herein. FIG. 1 comprises of an organizer 101, a mail client 102, a server 401, a call server 402, a plurality of invitees 104 and a telecommunications network 105. The organizer 101 plans the meeting and fixes a preferred date, time and list of invitees (invitees) 104 for the meeting. The organizer 101 sends the date and time of the meeting to the invitees 104 in an email using the mail client 102. The mail client 102 could be any suitable mail client application like Microsoft Outlook, Microsoft Outlook Express, and Mozilla Thunderbird and so on. The mail client 102 sends the emails to the invitees using a server 401. The server 401 could be a mail application server, an Intelligent Network (IN) server or any other suitable server. The server 401 stores the details of the meeting along with various options selected by the organizer 101 in a database present in the server 401. The organizer 101 may set options like urgency of the meeting, a predetermined time to wait for a response before attempting to contact non-responding invitees by accessing the server 401. The organizer 101 may also set the options using his mail client 102, which then communicates the options to the server 401.

The server 401 waits for the predetermined time for receiving responses from all the invitees. The predetermined time set by the organizer 101 could be a specific amount of time from sending the email or a specific amount of time away from the time of the meeting. In an example, the organizer 101 could set the predetermined time as 12 hours from the time of scheduling the meeting. In another example, the organizer 101 could set the predetermined time as 6 hours before the scheduled time of the meeting. After the predetermined time lapses, the server 401 determines the list of invitees who have not responded to the email, hereinafter referred to as non-responding invitees. The non-responding invitees may have not responded to the email due to a lack of access to email or any other reason. The organizer 101 may also not set any predetermined time, but set an urgency level for the meeting. The predetermined time has default values, which depend on the urgency of the meeting. For example, if the organizer 101 sets the urgency of the meeting as ‘very high’, then the server may wait for a shorter period of time, before attempting to contact non-responding invitees. If the urgency of the meeting is ‘low’, then the server may wait for a longer period of time before attempting to contact non-responding invitees. The server 401 retrieves the contact numbers of all the non-responding invitees. The contact numbers could be retrieved from the address book of the organizer 101. The contact numbers could also be retrieved from address books stored in the server 401. Contact numbers of a specific non-responding invitee could be a number belonging to a Public Switched Telephone

Number (PSTN) phone, a number belonging to a mobile phone, a number belonging to an Internet Protocol (IP) phone or a number belonging to any other telecommunications device capable of initiating communication or receiving communication.

The server 401 triggers a call server 402 to attempt to contact the non-responding invitees using one of the retrieved contact numbers. In some embodiments, the contact number used to contact the non-responding numbers may be any random number chosen from the retrieved contact numbers. In some other embodiments, the contact number used to contact the non-responding numbers may be a number which has been set as the preferred contact number. The invitee may set any one of his contact numbers as his preferred number. The preferred number set by the invitee may belong to his PSTN phone, his mobile phone or his IP phone. The invitee might also set preferences as to the time he wants to be contacted. For instance, an invitee might say that he is to be called on his mobile phone between 6 PM to 9 PM. An invitee might also set up options that he is to be contacted only in office hours. The organizer may also set a contact number of an invitee as the preferred number. The preferred number set by the organizer may belong to his PSTN phone, his mobile phone or his IP phone. The server 103 may also look at the cost of communication. For instance, a call to an IP phone may be cheaper than a mobile phone, so the server 103 will first attempt to initiate communication with the IP phone. If the communication with the IP phone fails, then the server 103 tries the other contact number in increasing order of cost of communication. The call server 402 initiates communication to the non-responding invitee. The type of communication initiated by the call server 402 depends on the type of telecommunications network to which the contact number belongs. If the contact number belongs to a PSTN phone, then the communication may be through an Interactive Voice Response (IVR) session. If the contact number belongs to a mobile phone, then the communication may be through an IVR session or a Short Message Service (SMS). If the contact number belongs to an IP phone, the session may be through any one of an IVR session, a SMS or an Instant Message (IM).

A non-responding invitee may respond to the reminder using the same type of session, as was used to notify him. The response of the non-responding invitee may be a confirmation message confirming his participation in the scheduled meeting. The response of the non-responding invitee may be a refusal to participate in the scheduled meeting. The response of the non-responding invitee may be a suggestion for a new time for the meeting. If IVR was used to notify the non-responding invitee, then the invitee may respond using the same IVR session. The response may be in the form of opting for an option presented to him in the IVR session. The IVR session could present the non-responding invitee with an option of pressing a specific key to confirm his availability for the meeting. The non-responding invitee may also get an option to press a second key to indicate his unavailability for the meeting. The non-responding invitee may also further be provided an option of suggesting a new date and time for the meeting. The IVR session could also use verbal inputs from the non-responding invitee.

If SMS was used to notify the non-responding invitee, then the non-responding invitee may reply to the SMS. The SMS sent by the non-responding invitee may be in a pre-specified format. If the non-responding invitee wants to send a SMS confirming his availability for the meeting, the SMS may contain “YES”. If the non-responding invitee wants to send a SMS confirming his unavailability for the meeting, the SMS may contain “NO”. If the non-responding invitee wants to send a SMS confirming his unavailability for the meeting and suggest a new timing for the meeting, the SMS, in an example, may contain “NO—dd/mm/yyyy, YY:YY”, where dd/mm/yyyy is the new date suggested for the meeting and YY:YY is the time suggested for the meeting in a 24 hour format.

If IM was used to notify the non-responding invitee, then the non-responding invitee may use the same IM session to respond. If the non-responding invitee wants to send an IM confirming his availability for the meeting, the IM may contain “YES”. If the non-responding invitee wants to send an IM confirming his unavailability for the meeting, the IM may contain “NO”. If the non-responding invitee wants to send an IM confirming his unavailability for the meeting and suggest a new timing for the meeting, the IM, in an example, may contain “NO—dd/mm/yyyy, YY:YY”, where dd/mm/yyyy is the new date suggested for the meeting and YY:YY is the time suggested for the meeting in a 24 hour format. The examples used herein are only for illustration purposes and should not be construed as limiting the coverage of the invention.

The call server 402, on receiving the response from the non-responding invitee, updates the server 401 with the response. The server 401 further informs the organizer 101 of the response though his mail client 102.

If the non-responding invitee does not respond on the contact number, then the server 401 instructs the call server 402 to initiate sessions to other contact numbers of the non-responding invitees. If the non-responding invitee does not respond on any of his contact numbers, then the call server 402 will be instructed by the server 401 to attempt to initiate sessions to the non-responding invitees after a specific period of time. The period of time may be specified by the organizer 101. The server 401 may instruct the call server 402 to attempt to contact non-responding invitees for a predetermined number of attempts. The predetermined number of attempts to attempt to contact the non-responding invitee may be specified by the organizer 101.

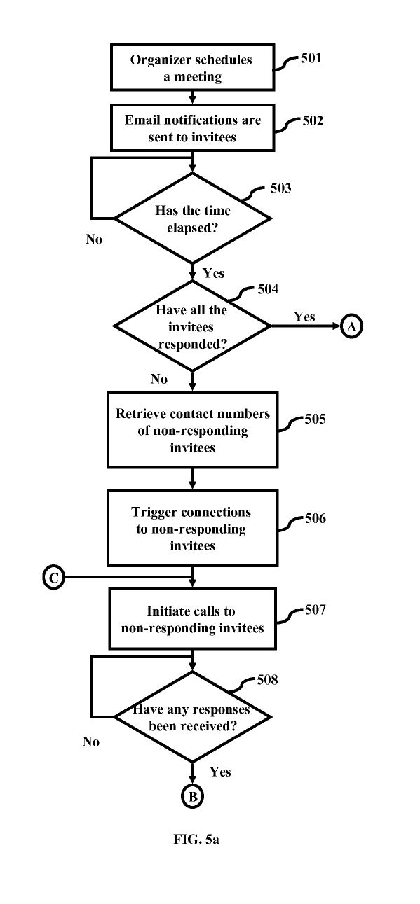

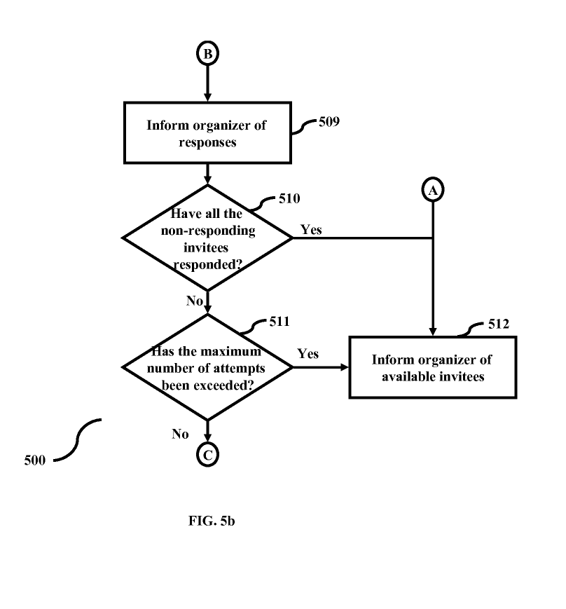

FIGS. 5a and 5b are flowcharts depicting the method for informing an invitee about a scheduled meeting, according to embodiments disclosed herein. The organizer 101 organizes (501) the meeting by suggesting a date and time for the meeting, including a list of invitees for the meeting using his mail client 102. The organizer 101 may also set options like urgency of the meeting, the predetermined time to wait for a response before attempting to contact non-responding invitees. The mail client 102 sends (502) notifications to the invitees in the form of an email. The notifications are sent to the invitees through the server 103. The server also receives the options as set by the organizer 101. The server 103, 401 keeps checking (503) if the predetermined time has lapsed. If the predetermined time has lapsed, the server 103, 401 further checks (504) if all the invitees have responded. If all the invitees have responded, the server 103, 401 informs (412) the organizer of the responses received along with the list of available invitees. If at least one of the invitees has not responded, then the server 103, 401 retrieves (505) contact numbers of the non-responding invitees. The server 103 triggers (506) connections to the non-responding invitees using the retrieved contact numbers. The server 103, 401 may use the call server 205, 304, 402 to trigger the connections. The call server 205, 304 may be a module present in the server 103, as depicted in FIGS. 1, 2 and 3. The call server 402 may also be present external to the server 401, as depicted in FIG. 4. The call server 205, 304, 402 initiates (507) communication with the non-responding invitees. The type of communication initiated by the call server 205, 304, 402 depends on the type of telecommunications network to which the contact number belongs. If the contact number belongs to a PSTN phone, then communication may be Interactive Voice Response (IVR). If the contact number belongs to a mobile phone, then communication may be IVR or a Short Message Service (SMS) communication. If the contact number belongs to an IP phone, communication may be any one of IVR, a SMS or an Instant Messaging (IM). The call server 205, 304, 402 checks (508) if any response has been received from any of the non-responding invitees. If any response has been received from any of the non-responding invitees, the response is send (509) to the organizer 101 through the server 103, 401 and mail client 102. The call server 205, 304, 402 further checks (510) if all the non-responding invitees have responded. If all the non-responding invitees have not responded, the call server 205, 304, 402 checks (511) if the predetermined number of times to attempt a contact has been exceeded. If the predetermined number of times to attempt a contact has not been exceeded, the call server 205, 304, 402 attempts to initiate (507) contact with the non-responding invitees at a different contact number than tried initially. If all the non-responding invitees have responded or the predetermined number of times to attempt a contact has been exceeded, the call server 205, 304, 402 informs the organizer 101 through the server 103 and mail client 102 of the list of available invitees for the meeting. The various actions in method 500 may be performed in the order presented, in a different order or simultaneously. Further, in some embodiments, some actions listed in FIGS. 5a and 5b may be omitted.

The embodiments disclosed herein can be implemented through at least one software program running on at least one hardware device and performing network management functions to control the network elements. The network elements shown in FIGS. 1, 2, 3 and 4 include blocks which can be at least one of a hardware device, or a combination of hardware device and software module.

The embodiment disclosed herein describes a method and system for confirming participation for a scheduled meeting. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method for informing invitees in a scheduled meeting about said meeting, said method comprising steps of:
a server retrieving contact numbers of at least one invitee of said meeting where confirmation from said invitee is not received before a predetermined time; and
said server contacting said invitee for said confirmation using at least one of said contact numbers.

2. The method, as claimed in claim 1, wherein said server retrieves said contact number from a plurality of address books present in said server.

3. The method, as claimed in claim 1, wherein said predetermined time is set by organizer of said meeting.

4. The method, as claimed in claim 1, wherein said server contacts said paid invitee through a call server.

5. The method, as claimed in claim 1, wherein said contact number belongs to one of
a mobile phone belonging to said invitee;
a PSTN phone belonging to said invitee;
an IP phone belonging to said invitee; and
a phone using a combination of one or more technologies.

6. The method, as claimed in claim 1, wherein said server contacts said invitee by selecting one of said contact numbers, said selection depending on a plurality of factors comprising of
preferences of said invitee;
preferences of said organizer; and
cost of contacting said invitee on said contact number.

7. The method, as claimed in claim 1, wherein said server contacts said paid invitee using Interactive Voice Response (IVR).

8. The method, as claimed in claim 1, wherein said server contacts said paid invitee using Short Messaging Service (SMS).

9. The method, as claimed in claim 1, wherein said server contacts said paid invitee using Instant Messaging (IM).

10. The method, as claimed in claim 1, wherein said organizer is notified if no response is received from said invitee.

11. A system for informing invitees in a scheduled meeting about said meeting, said server comprising of:
a means for retrieving contact numbers of at least one invitee of said meeting where confirmation from said invitee is not received before a predetermined time; and
a call server for contacting said invitee for said confirmation using at least one of said contact numbers.

12. The system, as claimed in claim 11, wherein said server is configured to retrieve said contact number from a plurality of address books present in said server.

13. The system, as claimed in claim 11, wherein said server is configured to contact said paid invitee using Interactive Voice Response (IVR).

14. The system, as claimed in claim 11, wherein said server is configured to contact said paid invitee using Short Messaging Service (SMS).

15. The system, as claimed in claim 11, wherein said server is configured to contact said paid invitee using Instant Messaging (IM).

16. The system, as claimed in claim 11, wherein said server is configured to notify organizer of said meeting if no response is received from said invitee.
